(19) United States
(12) Patent Application Publication
(10) Pub. No.: US 2002/0130707 A1
(43) Pub. Date: Sep. 19, 2002

(54) Voltage reference with improved current efficiency

(75) Inventors: Thomas A. Somerville, Tempe, AZ (US); Bob Maigret, Warwick, RI (US)

Correspondence Address: Robert D. Atkins, Semiconductor Components Industries, LLC, Patent Administration Dept-MD A230, P.O. Box 62890, Phoenix, AZ, 85082-2890, US

(73) Assignee: Semiconductor Components Industries, LLC

(21) Appl. No.: 09/769,815

(22) Filed: Jan. 26, 2001

(51) Int. Cl. G05F 1/10

(52) U.S. Cl. 327/540

(57) ABSTRACT

A voltage reference circuit (108) is disclosed. Voltage reference circuit (108) comprises an adjustable current source (202), a mirror circuit (302) and a bandgap circuit (206). The adjustable current source (204) outputs a current (I₃₄₂) to the mirror circuit (302), which then mirrors the current to the bandgap circuit (206). If the load (110) of the voltage reference cell (108) requires a greater current, a feedback current (I₃) is fed back to the adjustable current source (204) to increase its output current. The voltage reference circuit (108) of the present invention allows for a more efficient use of current.

### FIELD OF THE INVENTION

This invention relates to the field of voltage reference circuits and, more specifically, to a voltage reference circuit with improved current efficiency.

### BACKGROUND OF THE INVENTION

Bandgap reference circuits are well known to designers of analog circuits. These circuits are operable to provide a constant voltage to an external circuit regardless of environmental variations. Such reference circuits are useful in analog to digital converters where a reference voltage is compared against the values of samples converted. In switch mode power supplies, a source of reference voltage is needed for the controller and other components to function properly.

Numerous arrangements of bandgap circuits exist to solve various implementation problems. What these designs have in common is that the use of a fixed source of current to supply the bandgap part of the circuitry. While a stable source of voltage is produced these circuits are not as efficient as possible which can limit the magnitude of output current.

### BRIEF DESCRIPTION OF THE DRAWINGS

For a more complete understanding of the present invention and advantages thereof, reference is now made to the following descriptions, taken in conjunction with the following drawings, in which like reference numerals represent like parts, and in which:

FIG. 1 illustrates an exemplary switch mode power supply utilizing the voltage reference circuit of the present invention;

FIG. 2 is a block diagram of the voltage reference circuit in accordance with the teachings of the present invention; and

FIG. 3 is a detailed circuit diagram of the voltage reference circuit in accordance with the teachings of the present invention.

### DETAILED DESCRIPTION OF THE DRAWINGS

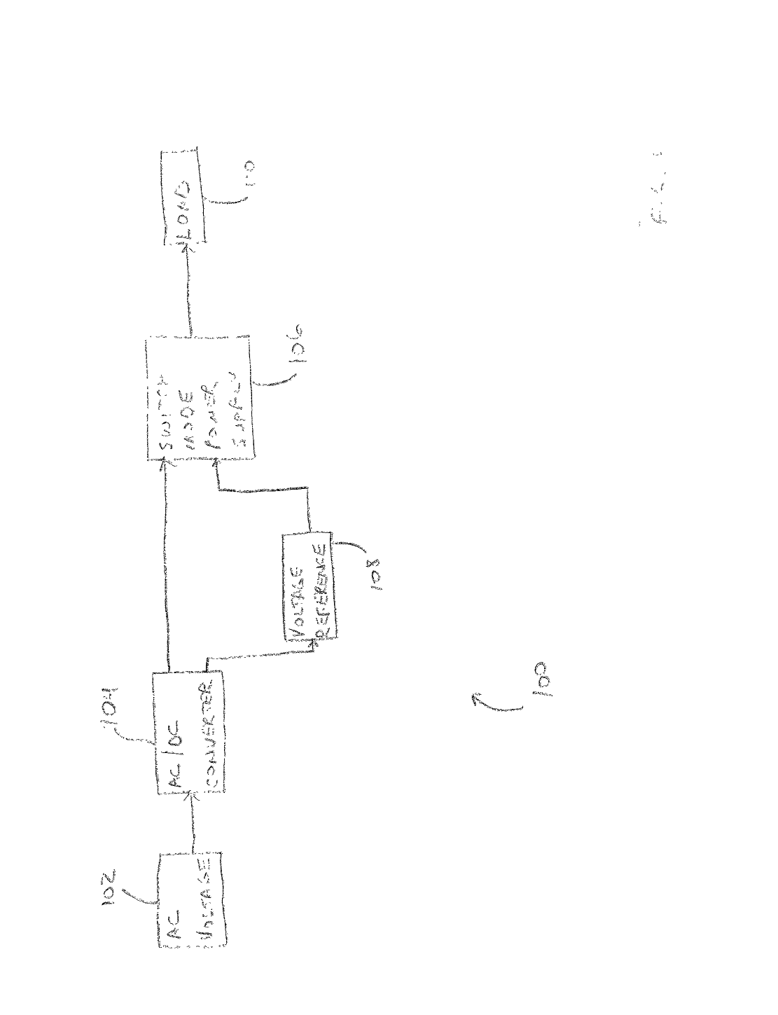

FIG. 1 illustrates an electrical system 100 in accordance with the teachings of the present invention. Illustrated is a source of AC voltage 102, an AC/DC converter 104, a current efficient voltage reference circuit 108, a switch mode power supply 106 and a load 110. In operation, the source of AC voltage 102, such as a household AC mains, supplies AC voltage to AC/DC converter 104. In a typical embodiment, AC/DC converter 104 comprises a diode network to convert AC voltage to a DC voltage. The output DC voltage supplies DC voltage to both voltage reference circuit 108 and switch mode power supply 106. Voltage reference circuit 108 produces an environmental stable reference voltage. In the present invention, voltage reference circuit 108 includes a variable reference current. The reference voltage is supplied to switch mode power supply 106. Switch mode power supply 106, in this embodiment, performs various tasks. First, it rectifies and smoothes the DC voltage waveform produced by the AC/DC converter 104. Also, based on a feedback voltage from load 110, a controller internal to switch mode power supply 106 controls the inductor charge and discharge duty cycle so as to provide the desired output voltage to load 110. The reference voltage is used by the controller internal to switch mode power supply 106. Load 110 may be a television set that requires one output voltage during operation and a second output voltage during a stand by mode.

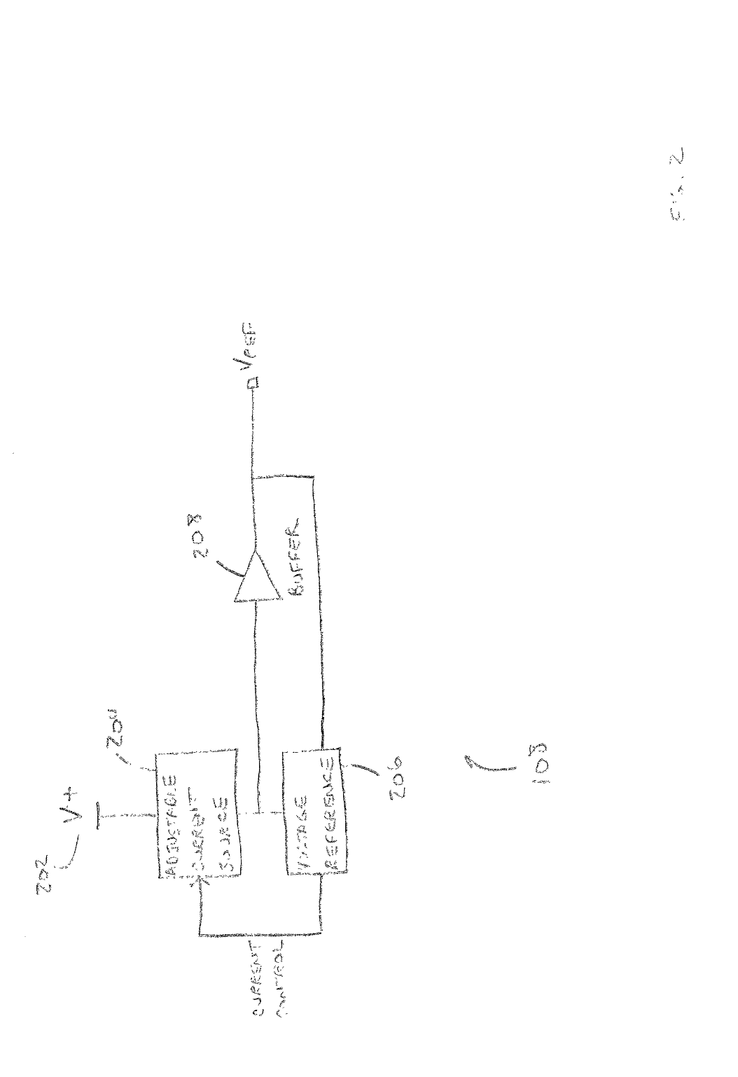

FIG. 2 illustrates a block diagram of current efficient voltage reference 108. Illustrated is a source of voltage 202, an adjustable current source 204, a voltage reference cell 206, a buffer 208, and a voltage reference output 210. The buffer provides current gain between the voltage reference cell and the output. The buffer current gain limits output current capability.

In operation, a source of voltage 202 supplies adjustable current source 204 which sets up a proportional current in voltage reference cell 206. Voltage reference cell 206 will then produce a reference voltage, V_{REF} 210. In this embodiment, the amount of current needed by the load that the reference voltage is attached to is fed back to adjustable current source 204 which will increase its output current and, consequentially, the current through the voltage reference cell 206 based on the amount of current needed. Thus, the present invention can efficiently respond to an increased current demand in an efficient manner.

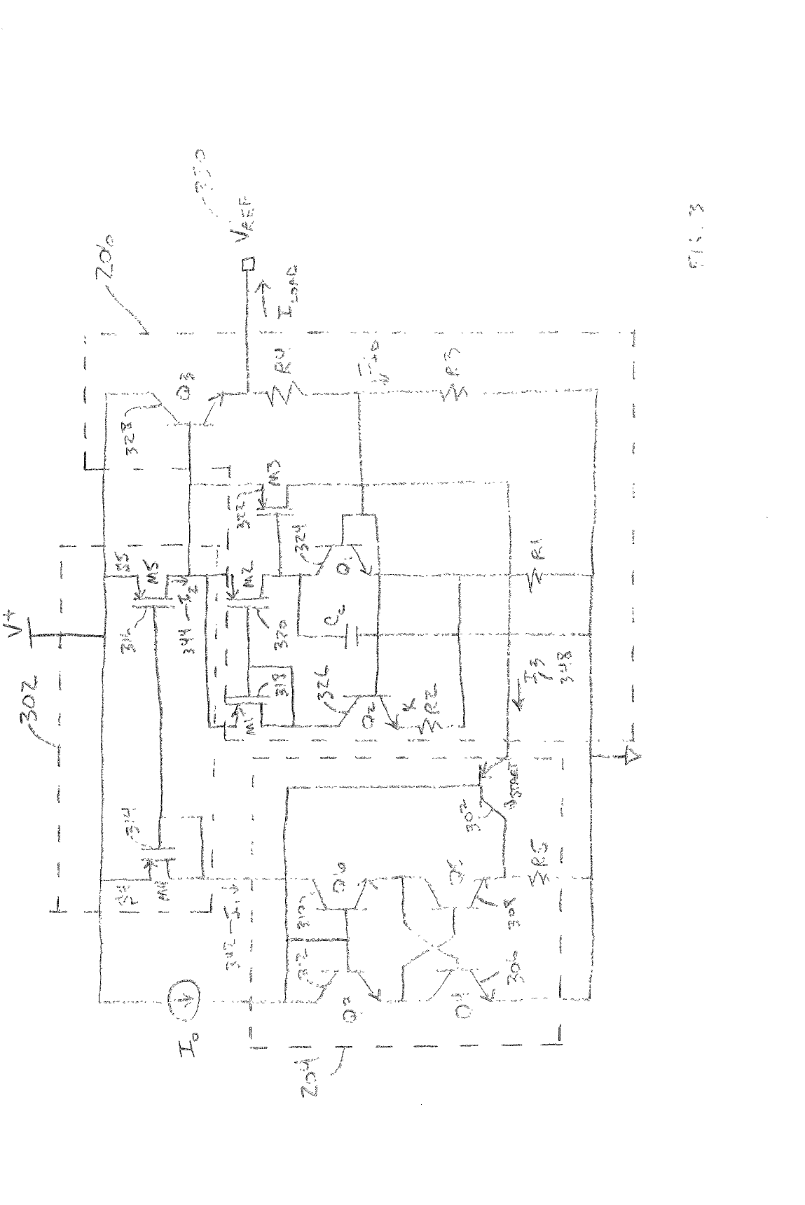

FIG. 3 is a circuit diagram of the voltage reference circuit 108 in accordance with the teachings of the present invention. Voltage reference circuit 108 comprises adjustable current source 204, a current mirror 302 and voltage reference cell 206.

Adjustable current source 204, in one embodiment, comprises four NPN transistors: fourth transistor Q₄ 306, fifth transistor Q₅ 308, sixth transistor Q₆ 310, and seventh transistor Q₇ 312. The emitter area of Q₅ 308 over the emitter area of Q₄ 306 is emitter ratio M and emitter ratio N is equal to the emitter area of Q₇ 312 over the emitter area of Q₆ 310. This configuration regulates the voltage across R5 to be (MNkT)/q, where kT/q is the thermal voltage. Therefore, current through resistor R₅ is constant, while current I₃ 348 depends on the load and thereby provides adjustment of the output current I₁ 342. Transistor Q_{START} 307 is a start transistor that serves to prevent feedback until the voltage reference is actually established. Adjustable current supply 204 is in the form of a proportional to absolute temperature current source, which is well known in the art. Adjustable current supply 204 outputs a current I₁ 342. Current mirror 302, of well-known design, outputs a current, I₂ 344, which is proportional to the input current, I₁ 342. The proportionality current is equal to the width to length (W/L) ratio of MOSFET transistor M₅ 316 over the W/L ratio of M₄ 314. This is known as the mirror ratio. In one embodiment the W/L ratio of MOSFET transistor M₅ 316 is S₅ and the W/L ratio of MOSFET transistor M₆ 314 is S₄. I₂ 344 is proportional to I₁ 342 by the W/L ratio of M₅ 316 (S₅) and M₄ 314 (S₄) (the mirror ratio). Therefore I₂=(S₅/S₄) I₁.

Voltage reference cell 206 receives I₂ 344 from current mirror 302. Transistor Q₃ 328 also receives current I₂. Q₃ 328 is an output transistor, which supplies current to the load at the node V_{REF} 330. Transistors Q₁ 324, Q₂ 326, M₁ 318, M₂ 320, and M₃ 322 of the voltage reference cell 206 produces a reference voltage, VREF 330.

In operation, if no load current is required, the current through Q₃ 328 is V_{REF}/(R₃+R₄). As load current increases, transistor Q₃ 328 will require a larger base current to output the required load current I_{LOAD} 331. This will require a larger current, I₂ 344, to be outputted by the current mirror 302. In order for adjustable current supply 204 to increase current output, a feedback is needed. This is accomplished by providing a current feedback I₃ 348 through transistor M₃ 322. M₃ 322 acts as a current regulator which will return any amount of current, I₃ 348, not needed by voltage reference cell 206 back to adjustable current source 204. As load current I_{LOAD} 331 increases, I₃ 348 will decrease. Adjustable current source 204 will then use the reduction in current, I₃ 348, to increase its output current, I₁ 342, since the current through R₅ remains constant. This in turn increases current I₂ 344 via current mirror 302, which will lead to an increase for load controller I_{LOAD} 331. Therefore, the present invention allows for a mechanism to increase current in a voltage reference when needed.

The efficiency of the present invention can be calculated by finding the ratio of the maximum current possible, I_{MAXLOAD}, to the quiescent current, Iq. The quiescent current is the total of the current in all the branches of the circuit. In this example:

$${I}_{Load}^{Max} = {β}_{{Q}_{3}} [ \frac{S5}{S4} ( \frac{{v}_{t} ln mn}{{R}_{5}} ) - \frac{2 {V}_{t} ln k}{{R}_{2}} ] - {I}_{fb}$$

$${I}_{q1} = {I}_{o} + {I}_{fb} + \frac{{V}_{t} ln mn}{{R}_{5}} + \frac{2 {V}_{t} ln k}{{R}_{2}}$$

Where ∃_{Q3} is the current gain for transistor Q₃, I_{fb} is the feedback current for the voltage cell, Vₜ is the thermal voltage and K is the emitter area ratio of Q₂ to Q₁. From the above two equations the efficiency of the present invention can be calculated:

$${η}_{1} = \frac{{I}_{Load}^{Max}}{{I}_{q1}}$$

In the prior art case of no current feedback, the current I₃ will be grounded instead of feedback to adjustable current source 204. In this case:

$${I}_{Load}^{Max} = {β}_{{Q}_{3}} [ \frac{S5}{S4} ( \frac{{v}_{t} ln mn}{{R}_{5}} ) - \frac{2 {V}_{t} ln k}{{R}_{2}} ] - {I}_{fb}$$

$${I}_{q0} = {I}_{0} + {I}_{fb} + \frac{{V}_{t} ln mn}{{R}_{5}} ( 1 + \frac{S5}{S4} )$$

$${η}_{0} = \frac{{I}_{Load}^{Max}}{{I}_{q0}}$$

The improvement in efficiency can be calculated by comparing the ratio of the individual efficiencies:

$$efficiency improvement = \frac{{η}_{1}}{{η}_{0}} = \frac{{I}_{Load}^{Max} / {I}_{q1}}{{I}_{Load}^{Max} / {I}_{q0}} = \frac{{I}_{q0}}{{I}_{q1}}$$

$$\frac{{I}_{q0}}{{I}_{q1}} = \frac{{I}_{o} + {I}_{fb} + \frac{{V}_{t} ln mn}{{R}_{5}} ( 1 + \frac{S5}{S4} )}{{I}_{o} + {I}_{fb} + \frac{{V}_{t} ln mn}{{R}_{5}} ( 1 + \frac{2 {R}_{5}}{{R}_{2}} \frac{ln k}{ln mn} )}$$

for the common case where

$$\frac{{I}_{o} + {I}_{fb}}{1 + \frac{S5}{S4}} << \frac{{V}_{t} ln mn}{{R}_{5}} then$$

$$\frac{{η}_{1}}{{η}_{0}} \approx \frac{1 + \frac{S5}{S4}}{1 + \frac{2 {R}_{5}}{{R}_{2}} \frac{ln k}{ln mn}}$$

Then, for appropriate choices of S₅, S₄, R₅, R₂, K and NM, the efficiency improvement of the present invention can be calculated. As an example, given a ratio S5/S4=6, k=8, mn=9, R₅=1.9KΩ, R₂=5.4KΩ, results in an efficiency gain of 4.2.

Although the present invention has been described in several embodiments, a myriad of changes, variations, alterations, transformations and modifications may be suggested to one skilled in the art. These include, for example, the substitution of various components such as NPN transistors for PNP transistors where appropriate. It is intended that the present invention encompass such changes, variations, alterations, transformations and modifications and that they fall within the spirit and scope of the appended claims.

1. A voltage reference circuit comprising an adjustable current source operable to adjust on output current based on a feedback current from a voltage reference cell.

2. The voltage reference circuit of claim 1, wherein the feedback current adjusts the magnitude of the current supplied to the voltage reference cell.

3. The voltage reference circuit of claim 1, wherein the adjustable current source further comprises a start transistor to prevent feedback until the circuit has outputted a reference voltage.

4. The voltage reference circuit of claim 1, further comprising a switch mode power supply coupled to the voltage reference cell.

5. The voltage reference circuit of claim 1, wherein the adjustable current source is operable to increase a load capability without increasing a quiescent current.

6. The voltage reference circuit of claim 1, wherein providing for a feedback current increases the current efficiency of the circuit.

7. An adjustable current source comprising:
a first input operable to receive an initial source current;
a series of transistors operable to produce an output current; and
a second input operable to receive a feedback current, wherein the adjustable current source is operable to adjust the output current based on the feedback current.

8. The adjustable current source of claim 7, further comprising a bandgap cell coupled to the adjustable current source.

9. The adjustable current source of claim 8, further comprising a start transistor operable to prevent feedback until the bandgap cell produces an output.

10. The adjustable current source of claim 7, further comprising a current mirror coupled between the adjustable current source and the bandgap cell.

11. The adjustable current source of claim 7, wherein the output current can be changed without requiring a greater quiescent current.

12. The adjustable current source of claim 7, wherein adjusting the output current based on the feedback current increases the current efficiency of the circuit.

13. A voltage reference circuit comprising:
an adjustable current source having an input to receive a source current, an output to output a first current and a feedback input to receive a feedback current;
a mirror circuit coupled to the adjustable current source operable to receive the first current and output a second current proportional to the first current; and
a bandgap cell coupled to the mirror current and operable to receive the second current and produce a reference voltage, the bandgap cell further comprising a feedback current wherein the feedback current is received by the feedback input of the adjustable current source to adjust the first current.

14. The voltage reference circuit of claim 13 further comprising a start transistor operable to block a feedback until a reference voltage is produced.

15. The voltage reference circuit of claim 13, further comprising a switch mode power supply coupled to the bandgap cell.

16. The voltage reference circuit of claim 13, wherein the use of the feedback current increases circuit efficiency.

17. A method of adjusting a circuit load in a voltage reference circuit comprising:
receiving an initial source current at an adjustable current source;
producing an output current at the adjustable current source;
receiving a feedback current; and
adjusting the output current in response to the feedback current.

18. The method of claim 17, further comprising the step of receiving the output current at a mirror circuit and outputting a second current in proportion to the output current.

19. The method of claim 17, further comprising the step of producing a reference voltage at a bandgap cell.

20. The method of claim 17, further comprising producing the feedback current at a bandgap cell, the feedback current based on a needed load current.

21. The method of claim 17, wherein the step of receiving a feedback current comprises waiting for a reference voltage to be established before receiving a feedback current.

22. The method of claim 17, further comprising the step of increasing circuit efficiency by providing the feedback current to the adjustable current source.
